(19) United States
(12) Patent Application Publication
(10) Pub. No.: US 2004/0215461 A1
(43) Pub. Date: Oct. 28, 2004

(54) Text-to-speech system for generating information announcements

(75) Inventor: J. William Whikehart, Novi, MI (US)

Correspondence Address: Robert K. Fergan, BRINKS HOFER GILSON & LIONE, P.O. Box 10395, Chicago, IL, 60610, US

(73) Assignee: Visteon Global Technologies, Inc.

(21) Appl. No.: 10/814,987

(22) Filed: Mar. 31, 2004

Related U.S. Application Data
(60) Provisional application No. 60/465,085, filed on Apr. 24, 2003.

(51) Int. Cl. G10L 13/08

(52) U.S. Cl. 704/260

(57) ABSTRACT

The present invention provides a system and method for generating an information announcement. The system includes a receiver to receive transmission information and a text-to-speech generator to create an audio message based on the transmission information. The text-to-speech generator utilizes a plurality of predefined templates stored in memory and inserts portions of the transmission information into one of the templates to create the message. The text-to-speech generator may randomly select the template, index through the templates based on a counter, or select a template based on some portion of the transmission information, such as, the artist's name.

### BACKGROUND

1. Field of the Invention

The present invention generally relates to a system and method for generating information announcements.

2. Description of Related Art

In modern radio receiver systems, such as, high definition radio or satellite radio, information such as song title and artist name are received in text form. Often, title and artist information is displayed visually on the radio unit. Another method to present textual information to the user is by using text-to-speech, using a text-to-speech generator in the radio. However, having the text-to-speech generator say the song title, alone and out of context, may not be useful to the listener. It is more helpful for the song title to be provided along with some context, for example, if the song title is “Blue Suede Shoes” and the artist is “Elvis”, the announcement may be “Now playing . . . Blue Suede Shoes by Elvis Presley”. Unfortunately, audibly providing the information in the same format may become monotonous for the user, thereby detracting from the system.

In view of the above, it is apparent that there exists a need for an improved system and method for generating information announcements.

### SUMMARY

In satisfying the above need, as well as overcoming the drawbacks and other limitations of the related art, the present invention provides a system and method for generating an information announcement. The system includes a receiver to receive transmission information and a text-to-speech generator to create an audio message based on the transmission information. The text-to-speech generator utilizes a plurality of predefined templates stored in memory, and inserts portions of the transmission information into one of the templates to create the message. The text-to-speech generator may randomly select the template, index through the templates based on a counter, or select a template based on some portion of the transmission information, such as, the artist's name.

In another aspect of the present invention, the text-to-speech generator determines if the artist information is plural or singular. The article in front of the artist's name may be modified based on whether the information is singular or plural. Further, the transmission information can include next-up information, information related to the next song to be played. The text generator may select a template based on the next-up information. In addition, the text-to-speech generator can add phrases to the template, where the phrases are associated with the transmission information, such as the artist information. To provide further enjoyment to the user, the phrases may be user definable.

In another aspect of the present invention, the audio signal generated from the text-to-speech generator is provided to an audio summer. The audio summer combines the audio signal with a music signal, thereby allowing the user to hear the information announcement and the related music at the same time.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system for generating information announcements, embodying the principles of the present invention; and

FIG. 2 is a block diagram of a method for generating information announcements, embodying the principles of the present invention.

### DETAILED DESCRIPTION

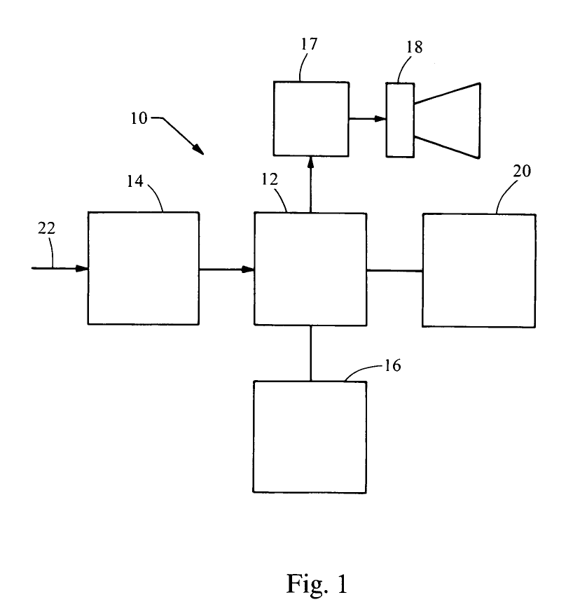

Referring now to FIG. 1, a system embodying the principles of the present invention is illustrated therein and designated at 10. As its primary components, the system 10 includes a text-to-speech generator 12, a receiver 14, and an audio output device 18.

The receiver 14 receives a signal transmission 22 including music and information such as the song title and artist name corresponding to the current song being played. The transmission signal may be received from an In-Band, On-Channel (IBOC), satellite radio, MP3, or other similar distribution system where song associated data, like the song title, is available.

The receiver 14 provides the information to the text-to-speech generator 12, which accesses its memory 20 to select a template from a table of predefined templates. The transmission information is thereafter embedded into the template so that a complete sentence is provided by the text-to-speech generator 12. In its simplest form, the predetermined template may be “Here is [song title] from the [artist]”, where the first blank is filled with the song title and the second blank is filled with the artist name. The template with the filled in transmission information is used to generate a corresponding audio signal. In addition, the audio signal containing the information announcement is combined with the actual music signal by an audio summer 17, providing a composite audio signal containing both the information announcement and the music. The composite audio signal is provided from the audio summer 17 to an audio output device 18, such as a radio amplifier or speaker.

In a first mode, the text-to-speech generator 12 selects the template from a table of predetermined templates using a randomly generated algorithm. Alternatively, in a second mode, a counter may be used to cycle through the templates stored in the table. In this way, a different template is used for each successive announcement providing more variety for the user. The text-to-speech generator 12 is configured, in a third mode, to select a template based on the artist name, such that the template selected is associated with the artist information.

Further, the text-to-speech generator 12 includes an algorithm to determine whether the artist name is singular or plural. A singular artist's name would be spoken as “ . . . from Elton John”, whereas a plural artist's name would be spoken as “ . . . from the Beetles”.

In addition, some transmissions, such as IBOC transmissions, may include “next up” song information (meaning that the radio will receive text indicating the song to be played next). When the next up information is included in the transmission information, the processor 12 may also be configured to select a template including a phrase, such as, “Up next, [song title] by the [artist]”, where the first blank is the song title and the second blank is filled with the artist information of the song to be played next.

To provide added variety to the user, certain additional phrases may be selected based on the transmission information. For example, if the artist's name is “Elvis” and the song title is “Blue Suede Shoes”, the additional phrase could be “Thank you very much”, making the announcement read “Here is Elvis singing Blue Suede Shoes. Thank you very much”. Here, the sentence, “Thank you very much.” has been added because this is a catch phrase associated with the artist's name, Elvis Presley. If a particular artist is not in the table, no additional phrase is appended. The user input device 16 is further provided to allow users to generate their own phrases and store them in the memory 20. The user input device 16 may, without limitation, include voice control, keyboard input, or the like and may be physically connected to the system, or alternatively, wirelessly connected.

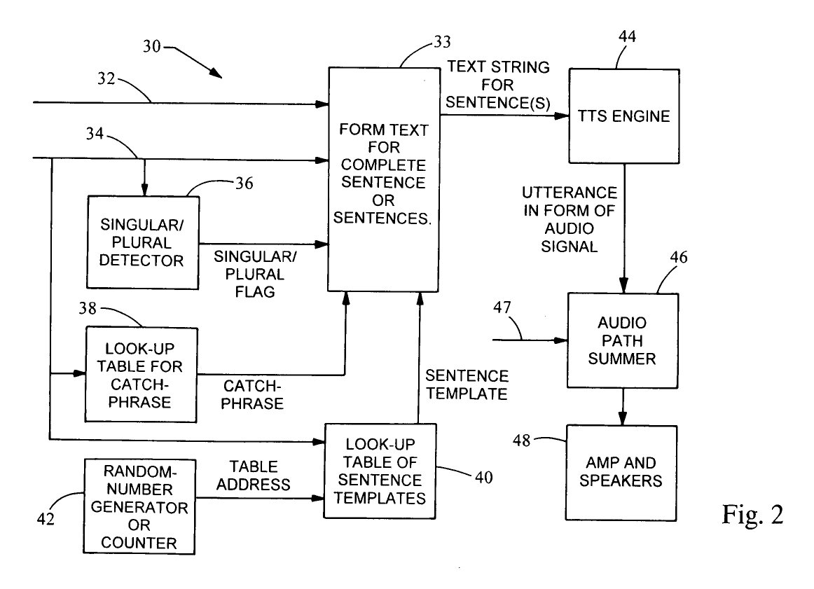

Now referring to FIG. 2, a method 30 is provided for generating information announcements. Transmission information is provided to block 33, such as the song title along line 32 and the artist name along line 34. In addition, the artist name is provided along line 34 to block 36, where the artist name is analyzed to determine if the artist is singular or plural. One method of determining if the artist's name is plural includes searching for an “s” at the end of the text string. To be used in assembling the information announcement, a signal is provided from block 36 to block 33 indicating if the artist's name is singular or plural.

The artist's name is also provided to a lookup table for adding a catch phrase as denoted by block 38. The catch phrase associated for each artist may be randomly chosen or chosen using a counter to index through all of the catch phrases for an associated artist. For further use in assembling the information announcement, the catch phrase is provided from block 38 to block 33.

Similarly, the artist's name is also provided to a template lookup table as denoted by block 40. A template is selected from the lookup table of templates utilizing a random number generator or a counter to index through each of the sentence templates as denoted by block 42. In addition, the sentence templates may be organized relative to a particular artist. Therefore, only certain templates would be used with a specific artist. The template is provided from block 40 to block 33, where the information announcement is formed based on the transmission information including the song title, artist name and similar information.

Block 33 combines the transmission information with the singular/plural information provided from block 36, the additional catch phrase information provided from block 38, and the selected template provided from block 40 to generate a text string representative of the information announcement. The text string is provided from block 33 to block 44, where a text-to-speech engine generates an audio signal based on the text string. The audio signal is provided from block 44 to an audio summer 46, where the audio signal is combined with the music signal 47 and provided to the radio amplifier and/or speakers as denoted by block 48.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I/We claim:

1. A system for generating an information announcement, the system comprising:
a receiver to receive transmission information;
a text-to-speech generator in communication with the receiver, the text-to-speech generator being configured to receive transmission information from the receiver, select a template from a plurality of predefined templates, and insert portions of the transmission information into the template creating a message.

2. The system according to claim 1, wherein the text-to-speech generator is configured to randomly select a template from the plurality of predetermined templates.

3. The system according to claim 1, wherein the text-to-speech generator is configured to select a template from the plurality of predetermined templates based on a counter.

4. The system according to claim 1, wherein the text-to-speech generator is configured to select a template from the plurality of predefined templates based on the transmission information.

5. The system according to claim 4, wherein the text-to-speech generator is configured to select a template from the plurality of predefined templates based on artist information in the transmission information.

6. The system according to claim 1, wherein the text-to-speech generator is configured to determine if artist information is in the transmission information and to determine if the artist information is plural.

7. The system according to claim 1, wherein the transmission information includes next up information, and the text-to-speech generator selects the template based on the next up information.

8. The system according to claim 1, wherein the text-to-speech generator is configured to add phrases to the template, where the phrases are associated with the transmission information.

9. The system according to claim 8, wherein the phrases are associated with artist information in the transmission information.

10. The system according to claim 8, further comprising an input device, wherein the phrases are user definable via the input device.

11. The system according to claim 1, further comprising an audio summer configured to combine the message with a music signal.

12. A method for generating an information announcement, the method comprising:
receiving transmission information;
selecting a template from a plurality of predefined templates;
creating a message by inserting portions of the transmission information into the templates; and
audibly communicating the message to a user.

13. The method according to claim 12, wherein the template is selected randomly.

14. The method according to claim 12, wherein the template is selected from the plurality of predefined templates based on a counter.

15. The method according to claim 12, wherein the template is selected from the plurality of predefined templates based on the transmission information.

16. The method according to claim 15, wherein the template is selected from the plurality of predefined templates based on an artist associated with the transmission.

17. The method according to claim 12, further comprising determining if artist information contained within the transmission information is plural.

18. The method according to claim 12, wherein the transmission information includes next up information and the template is selected based on the next up information.

19. The method according to claim 12, further comprising adding phrases to the template, where the phrases are associated with the transmission information.

20. The method according to claim 19, wherein the phrases are associated with artist information contained within the transmission information.

21. The method according to claim 20, further comprising entering the phrases to be added to the template.

22. The method according to claim 12, further comprising summing the message with a corresponding music signal.
